(19) United States
(12) Patent Application Publication
(10) Pub. No.: US 2003/0023451 A1
(43) Pub. Date: Jan. 30, 2003

(54) Method and apparatus for identifying privacy levels

(76) Inventors: Barry E. Willner, Briarcliff Manor, NY (US); David P. Greene, Ossining, NY (US); Edith H. Stern, Yorktown Heights, NY (US); Philip Shi-lung Yu, Chappaqua, NY (US)

Correspondence Address: BUCKLEY, MASCHOFF, TALWALKAR, & ALLISON, 5 ELM STREET, NEW CANAAN, CT, 06840, US

(21) Appl. No.: 09/917,328

(22) Filed: Jul. 27, 2001

(51) Int. Cl. G06F 17/60

(52) U.S. Cl. 705/1; 705/26

(57) ABSTRACT

Embodiments of the present invention provide a system, method, apparatus, means, and computer program code for notifying a user of a privacy level associated with an interaction conducted by or otherwise involving the user either before, during or after the interaction. Once a determination is made regarding what level of privacy is being applied to an interaction, a notification may be sent to the user to inform the user of such privacy level. In some embodiments, the notification may include an icon or other image that is displayed on a user device (e.g., computer, cellular telephone) or with software that the user is using during the interaction. Different interactions between the user and the service provider may have different privacy levels associated with them.

### FIELD OF THE INVENTION

The present invention relates to a method and apparatus for identifying one or more privacy levels associated with an interaction and, more particularly, embodiments of the present invention relate to methods, means, apparatus, and computer program code for notifying a user of a privacy level applied to the interaction.

### BACKGROUND OF THE INVENTION

Privacy is a significant issue to many people browsing the World Wide Web (“Web”), making purchases at Web sites, engaging in online chat rooms or merely searching for information. Some state and federal regulations already have been implemented to protect the privacy and other rights of Web users and other people conducting online transactions. In addition, privacy and other advocacy groups monitor activities by Web sites and other online service providers regarding privacy protection afforded to users of the Web sites and other service providers.

Many Web sites and other service providers have developed and display privacy policies that attempt to govern how the service providers will collect, use, and/or distribute information and data collected from users. Unfortunately, such privacy policies are often vague, difficult to locate and apply broadly to all transactions and other interactions conducted between the service providers and users. In addition, a user visiting a Web site may have to be proactive in searching for a Web site's privacy policy. As a result, a service provider might collect, use and/or disclose information provided by one user differently than information provided by another user, even though the service provider is complying with its stated privacy policy in both instances. Thus, a user involved in an interaction with a service provider (e.g., purchasing a product via a Web site operated by the service provider, providing credit card or mailing address information) is not provided information regarding the user's specific interaction with the service provider and how the service provider is applying its privacy policy with respect to the user in the specific interaction.

It would be advantageous to provide a method and apparatus that overcame the drawbacks of the prior art. In particular, it would be desirable to provide a method and apparatus for identifying a level of privacy applied during or after an interaction between a user and a service provider and providing a notification of the level of privacy to the user either during the interaction or after the interaction. In addition, it would be desirable to provide a method and apparatus for allowing the user to know what level of privacy is to be applied by a service provider to an interaction between the user and the service provider and/or to data collected or received by the service provider during the interaction.

### SUMMARY OF THE INVENTION

Embodiments of the present invention provide a system, method, apparatus, means, and computer program code for notifying a user of a privacy level associated with an interaction conducted by or otherwise involving the user. According to embodiments of the present invention, a determination is made regarding a privacy level applied to an interaction by a service provider involved in the interaction. For example, in one interaction, a user may be supplying information to a Web site as part of purchasing a product from the Web site. The Web site might later disclose the information to another party. As another example interaction, a Web site may be collecting information about a user as the user navigates portions of the Web site, clicks on different links or advertisements displayed on the Web site, etc. The Web site may use the information to determine which advertisements to display to the user during a later interaction.

In some embodiments, one privacy level may be an indicator of no privacy being afforded by a service provider during or after an interaction, particularly in regard to data collected or generated by the service provider during the interaction. Another privacy level may be an indicator that a service provider is recording or collecting data from or about a user during an interaction. A third privacy level may be an indicator that a service provider is disclosing or later may disclose user information or other data as part of aggregate information collected from or about many users involved with the service provider in interactions. A fourth privacy level may be an indicator that a service provider is disclosing or later will disclose individual user information or other data collected from or about a user involved in an interaction. Thus, a privacy level may indicate that a Web site or other service provider collects but does not share information, collects and shares aggregate information, collects and shares individual information, collects and publishes information, etc.

Once a determination is made regarding what level of privacy is being applied to an interaction, a notification may be sent to the user to inform the user of such privacy level. In some embodiments, the notification may include an icon or other image that is displayed on a user device (e.g., computer, cellular telephone) that the user is using during the interaction. For example, browser, interface or other software operating on a user's computer might display an image of an ear on the user device when the service provider is recording or storing information provided by a user during the interaction. Alternatively, the browser, interface or other software might display an image of a megaphone or a user's computer screen if the service provider is, or may in the future, distribute information about or received from the user to another party. Different interactions between the user and the service provider may have different privacy levels associated with them.

Additional objects, advantages, and novel features of the invention shall be set forth in part in the description that follows, and in part will become apparent to those skilled in the art upon examination of the following or may be learned by the practice of the invention.

According to embodiments of the present invention, a method for providing notification of a privacy level may include determining a plurality of levels of privacy; determining one of the plurality of privacy levels that applies to an interaction conducted by a user; and providing a notification of the privacy level to the user. In a further embodiment, a method for providing notification of a privacy level may include determining an interaction associated with a user; determining one of a plurality of privacy levels that is associated with the interaction; and providing a notification of the privacy level. In another embodiment, a method for providing notification of a privacy level may include determining a privacy level; making a determination as to whether a party involved in an interaction with a user complies with the privacy level; and providing a notification regarding the determination.

According to embodiments of the present invention, a system for providing notification of a privacy level may include a memory; a communication port; and a processor connected to the memory and the communication port, the processor being operative to determine a plurality of levels of privacy; determine one of the plurality of privacy levels that applies to an interaction conducted by a user; and provide a notification of the privacy level to the user. In a further embodiment, the processor may instead be operative to determine an interaction associated with a user; determine one of a plurality of privacy levels that is associated with the interaction; and provide a notification of the privacy level. In another embodiment, the processor may instead be operative to determine a privacy level; make a determination as to whether a party involved in an interaction with a user complies with the privacy level; and provide a notification regarding the determination.

According to embodiments of the present invention, a computer program product in a computer readable medium for providing a notification of a privacy level may include first instructions for identifying a plurality of levels of privacy; second instructions for identifying one of the plurality of privacy levels that applies to a first interaction conducted by a user; and third instructions for sending a notification of the one of the plurality of privacy levels to the user. In a further embodiment, a computer program product in a computer readable medium for providing a notification of a privacy level may include first instructions for identifying an interaction associated with a user; second instructions for identifying one of a plurality of privacy levels that is associated with the interaction; and third instructions for sending a notification of the privacy level. In another embodiment, a computer program product in a computer readable medium for providing a notification of a privacy level may include first instructions for identifying a privacy level; second instructions for creating a determination as to whether a party involved in an interaction with a user complies with the privacy level; and third instructions for providing a notification regarding the determination. In still another embodiment, a computer program in a computer readable medium for providing notification of a privacy level may include first instructions for receiving data indicative of a level of privacy involved in an interaction; and second instructions for displaying on a device a notification indicative of the level of privacy.

According to embodiments of the present invention, an apparatus for providing a notification of a privacy level may include means for identifying a plurality of levels of privacy; means for identifying one of the plurality of privacy levels that applies to a first interaction conducted by a user; and means for sending a notification of the one of the plurality of privacy levels to the user. In a further embodiment, an apparatus for providing a notification of a privacy level may include means for identifying an interaction associated with a user; means for identifying one of a plurality of privacy levels that is associated with the interaction; and means for sending a notification of the privacy level. In another embodiment, an apparatus for providing a notification of a privacy level may include means for identifying a privacy level; means for creating a determination as to whether a party involved in an interaction with a user complies with the privacy level; and means for providing a notification regarding the determination.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is an illustration of a privacy notification displayed on a computer in accordance with the method of FIG. 1;

FIG. 3 is an illustration of a privacy notification displayed on a personal digital assistant in accordance with the method of FIG. 1;

FIG. 4 is a flowchart of a second embodiment of a method in accordance with the present invention;

FIG. 5 is a flowchart of a third embodiment of a method in accordance with the present invention;

FIG. 6 is a block diagram of system components for an embodiment of an apparatus usable with the methods of FIGS. 1, 4 and 5;

FIG. 7 is a block diagram of components for an embodiment of a server of FIG. 6;

FIG. 8 is an illustration of a representative user information database of FIG. 7;

FIG. 9 is an illustration of a representative user device information database of FIG. 7;

FIG. 10 is an illustration of a representative service provider information database of FIG. 7; and

FIG. 11 is an illustration of a representative interaction information database of FIG. 7.

### DETAILED DESCRIPTION

Applicants have recognized that there is a need for systems and methods that allow a user to know what level of privacy, if any, is being applied to an interaction between the user and a service provider. In addition, applicants have recognized that there is a need to provide privacy level information to a user involved in an interaction with a service provider while the interaction is taking place and, in some cases, even after the interaction is completed. These and other features will be discussed in further detail below, by describing a system, individual devices, means, and processes according to embodiments of the invention.

A service provider may be or include any type of Web site, on-line entity, or electronically accessible business, market, resource, database, government agency, information source, etc. In some embodiments, a service provider may be part of or provided by a conventional “brick-and-mortar” entity.

An interaction between a user and a service provider may be or involve many different kinds of activities. For example, an interaction may be or include a user conducting a transaction with a service provider, a user making an online purchase from a seller; a user accessing or using a Web site or a feature of a Web site; a user downloading data from a Web site or electronic database; a user providing data to a Web site or electronic database; a user navigating through the Web, a Web site, a database or some other electronic network, software object; a user participating in a chat session, auction, news feed, etc. sponsored by a Web site; a user sending an email to or otherwise communicating with a service provider; etc.

A user and a service provider may engage in many interactions during a single communication session between the user and the service provider. Thus, an interaction may be or include one or more communications to, from or between a user and service provider. For example, an interaction may comprise all of the communications back and forth between a service provider and a user. Alternatively, an interaction may comprise just one or a few of such communications between the user and the service provider. In some cases, a user and/or service provider may not be aware of one or more of the individual communications sent or received during the interaction between them. An interaction my be or include any situation in which a user provides a communication to, or receives a communication from, a service provider, and vice versa.

Process Description

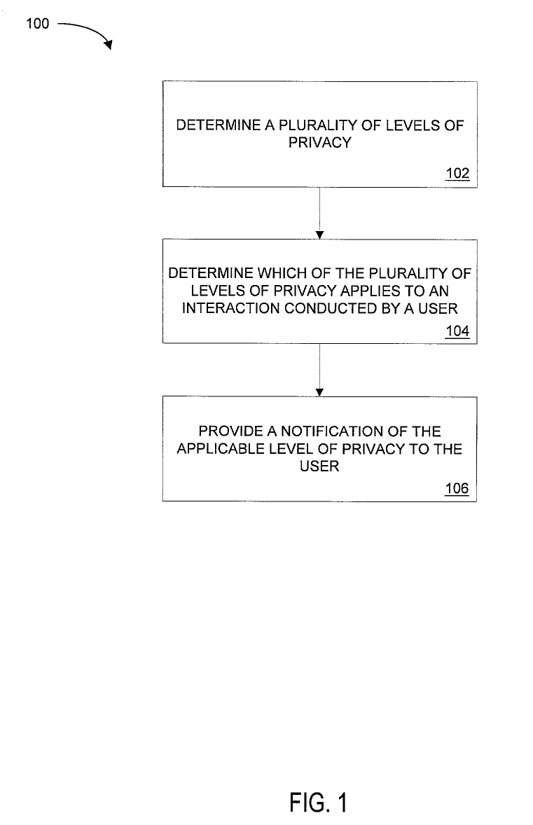

Reference is now made to FIG. 1, where a flow chart 100 is shown which represents the operation of a first embodiment of the present invention. The particular arrangement of elements in the flow chart 100 is not meant to imply a fixed order to the steps; embodiments of the present invention can be practiced in any order that is practicable. In some embodiments, some or all of the steps of the method 100 may be performed or completed by a server, user device and/or another device, as will be discussed in more detail below. The method is suited for implementation by a service provider, or by another party or device on behalf of one or more service providers and/or one or more users.

Processing begins at a step 102 during which a plurality of privacy levels is determined. For example, a service provider may determine five different privacy levels that the service provider might apply during interactions with users.

An interaction between a user and a service provider may have many potential privacy levels. Typically, such an interaction may provide an opportunity for the service provider to collect data from the user (e.g., credit card information, address information, personal information, location information) and/or information about the user. Information collected about the user may include information regarding what pages of a Web site the user visited, how long the user stayed on each page, what links displayed on the Web site the user clicked on, how the user navigated the Web site, what advertisements appeared to garner the most interest from the user, what other Web sites has the user visited, etc.

There may be many privacy levels associated with an interaction between a service provider and a user. For example, a service provider may collect information obtained from or about a user but not disclose the information. As another example, a service provider may collect information from or about a user, but only keep, use or disclose the information in an aggregate format along with information regarding other users such that information regarding a specific user cannot be identified (e.g., a total number of visitors to a Web site, a total number of downloads from a database during a specific month). As a further example, a service may collect user information and proactively attempt to sell, publish or distribute the user information, either in the aggregate or by individual user. Each of these circumstances may constitute a different level of privacy for an interaction regarding data or information collected or obtained during the interaction. In some interactions, a service provider might not provide any privacy at all.

In some embodiments, information regarding one or more users and/or one or more user devices may be stored in, or accessed from, a user information database and/or a user device information database. Likewise, in some embodiments, information regarding one or more service providers may be stored in, or accessed from, a service provider information database. Similarly, in some embodiments, information regarding one or more privacy levels may be stored in, or accessed from, a privacy information database. Furthermore in some embodiments, information regarding one or more interactions may be stored in, or accessed from, a privacy information database.

Privacy levels may be set by a service provider according to its privacy policy, government or other regulations, privacy or other advocacy groups, etc. Different service providers may use different privacy levels and/or notifications of privacy levels. In some cases a party or device implementing the method 100 may establish a set of privacy levels, some or all which are available at, or used by, individual service providers. Thus, one or more of the privacy levels determined during the step 102 may be based on a specific user, a specific service provider, a type of transaction or other interaction being conducted or to be conducted between the user and the service provider, the time/date of a transaction or other interaction being conducted or to be conducted between the user and the service provider, etc.

The step 102 may be completed in a variety of ways. For example, a service provider or other party implementing the method 100 may establish the privacy levels or receive a notification of the privacy levels from another entity (e.g., government agency, advocacy or consumer protection organization that establishes the privacy levels). As another example, a service provider or other party implementing the method 100 may select one or more of the privacy levels from a group of privacy levels previously indicated by the service provider or a user to be acceptable to the service provider and/or user. As a further example, a service provider or user may request or command that an interaction be conducted in accordance with one or more privacy levels. For example, a user or a service provider may establish a history of use of one or more privacy levels and may choose to use or apply one of them during an interaction

In some embodiments the step 102 or determining a one or more levels of privacy may be or include one or more of the following: establishing a plurality of privacy levels; receiving an indication of a plurality of privacy levels; selecting a plurality of privacy levels from privacy levels previously indicated by a user to be acceptable to the user; selecting a plurality of privacy levels from privacy levels previously indicated to be acceptable to a party involved in a interaction; receiving an indication from a user of a group of privacy levels acceptable to the user and selecting one or more plurality of privacy levels from the group of privacy levels; receiving an indication from a party involved in an interaction of a group of privacy levels acceptable to the party and selecting one or more plurality of privacy levels from the group of privacy levels; receiving a request from a party to conduct each interaction involving the party in accordance with at least one of a group privacy levels; receiving a request from a user to conduct each interaction involving the user in accordance with at least one of a plurality of privacy levels; etc.

In some embodiments, one or more of the privacy levels determined during the step 102 may be based, at least in part, on one or more of the following: a request received from a user and/or a service provider prior to, during, or after an interaction involving the user and/or service provider; a type of data that may be provided or received during an interaction; a request from a user and/or service provider involved in an interaction regarding data provided by the user and/or data received by the service provider during the interaction; a requirement of a user regarding data provided by the user during an interaction; a requirement of a service provider regarding data received by the service provider during an interaction; a disclosure or use of data provided by a user during an interaction; etc. In some embodiments, one or more of the privacy levels determined during the step 102 may be or include one or more of the following: a requirement that a user be informed of data received, retained, disclosed, modified, published, etc. by a party involved in an interaction.

During a step 104, service provider or other entity or device implementing the method 100 determines which privacy level determined during the step 102 applies to an interaction conducted by a user. An interaction “conducted” by a user or other party may be or include an interaction participated or engaged in by the user or other party, an interaction initiated or completed by the user or other party, an interaction associated with the user or other party, or an interaction involving or relating to the user or other party in some capacity. In some embodiments, the determination made during the step 104 may occur while the interaction is taking place or after the interaction is completed.

In some embodiments, a service provider may provide a user with a list or description of one or more privacy levels (e.g., the privacy levels determined during the step 102) that a user can select from for use with an interaction between the user and the service provider. The user can make a selection and provide a notification of the selection to the service provider. For example, a user may opt to have a service provider store information received from the user during an interaction, but not allow the service provider to disclose the information to any one else or use the information for any purpose other than for the current interaction. As another example, a user may allow a service provider to collect information from the user and then sell the information to other companies.

In some embodiments, a service provider implementing the step 104 may determine what it is doing or what it intends to do with information collected from or about a user involved in an interaction. This determination may be based on the user, the type of interaction, the time or day of the interaction, the occurrence of an external event, etc. The service provider may then identify one of the privacy levels determined during the step 102 that applies or comports with the service provider's action or intention. A service provider then may choose one of these privacy levels or allow the user to select from among these privacy levels.

In some embodiments, a service provider implementing the step 104 may receive a notification, request, etc. from a user regarding a privacy level that the user wants applied to one or more interactions between the user and the service provider. Alternatively, the service provider may receive a request or other notification from a user or other party regarding a minimum privacy level or other privacy requirement that should be used during one or more interactions between the user and the service provider. The service provider can then determine which of the privacy levels determined during the step 102 should be used to meet or exceed the minimum privacy level or privacy requirement specified by the user.

In some embodiments, a service provider may determine which, if any, of the privacy levels determined during the step 102 were used in one or more previous interactions between the service provider and a user. Such information may be found in a cookie stored on a device associated with the user during or after a previous interaction involving the user. The service provider then may apply the same privacy level to a current or new interaction between the service provider and the user.

In some embodiments the step 104 or determining which privacy level applies to an interaction between a service provider and a user may be or include one or more of the following: determining if any of a plurality of privacy levels were previously indicated by the service provider, user, and/or another party as being acceptable; identifying at least one privacy level that was applied during a previous interaction involving the service provider and/or user; providing an indication to the user or other party of a selection of a privacy level and receiving from the user or other party a consent to conduct the interaction in accordance with the privacy level; receiving a request from the service provider and/or user to conduct the interaction in accordance with a specific privacy level, privacy requirement or minimum privacy standard; etc.

During a step 106, a service party or other entity or device implementing the step 106 provides a notification regarding the privacy level determined during the step 104 to a user involved in the interaction and/or to some other party or device monitoring, associated with, or somehow involved in the interaction. The notification provided during the step 106 may be in any form or format, including, but not limited to, a HTTP (Hypertext Transfer Protocol), HTML (Hypertext Mark-up Language) or FTP (File Transfer Protocol) transmission, XML (Extensible Mark-up Language) feed, email message, instant message communication, facsimile or radio transmission, telephone call, beeper signal, electronic signal or communication, etc. In some embodiments, the step 106 may occur during an interaction associated with the notification or after the interaction associated with the notification.

In some embodiments, a notification may be sent from a service provider to a user device (e.g., computer, personal digital assistant, cellular telephone) used by a user during the interaction. For example, the notification provided during the step 106 might be or include an icon, image, signal, message or other communication that is displayed on the user device or used to generate an icon, image, symbol, message, etc. that is displayed on the user device. In some embodiments, the notification sent during the step 106 may include an audible component that is played by a device or used to generate an audible message, tone, sound, musical note, etc. indicative of the privacy level determined during the step 104.

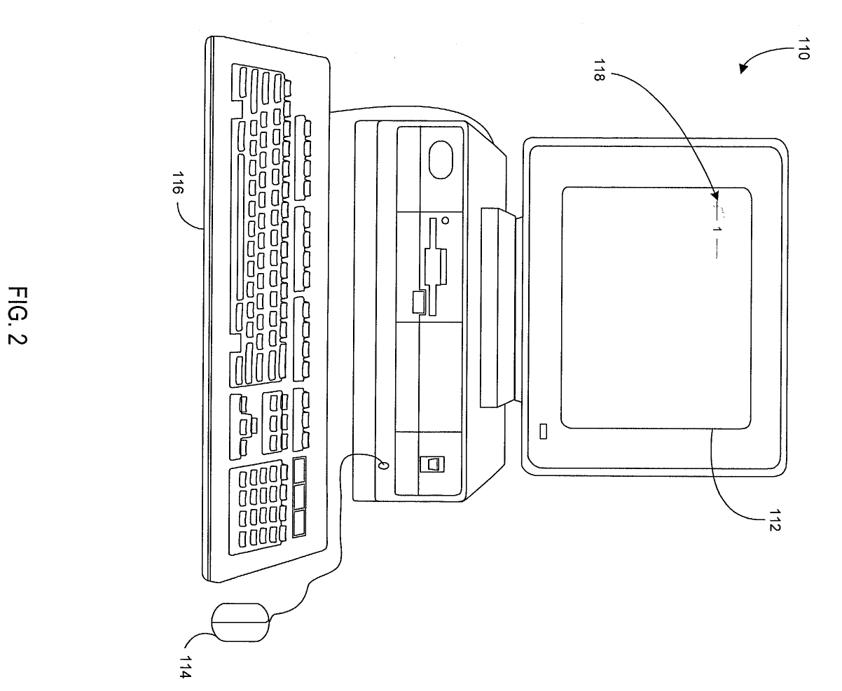

Now referring to FIG. 2, a conventional computer 110 is illustrated with a display 112, mouse 114, and keyboard 116. A computer 100 displays a privacy notification or image 118 and indicates a privacy level of “1” for an interaction. In some embodiments, a privacy level of “1” may indicate that a service provider may disclose information received from a user or about a user involved in an interaction with the service provider in aggregate with other users, but not individually. In some embodiments, an image or icon of an ear or recording device may be used instead of the image 188 to indicate a privacy level of “1” or other privacy level.

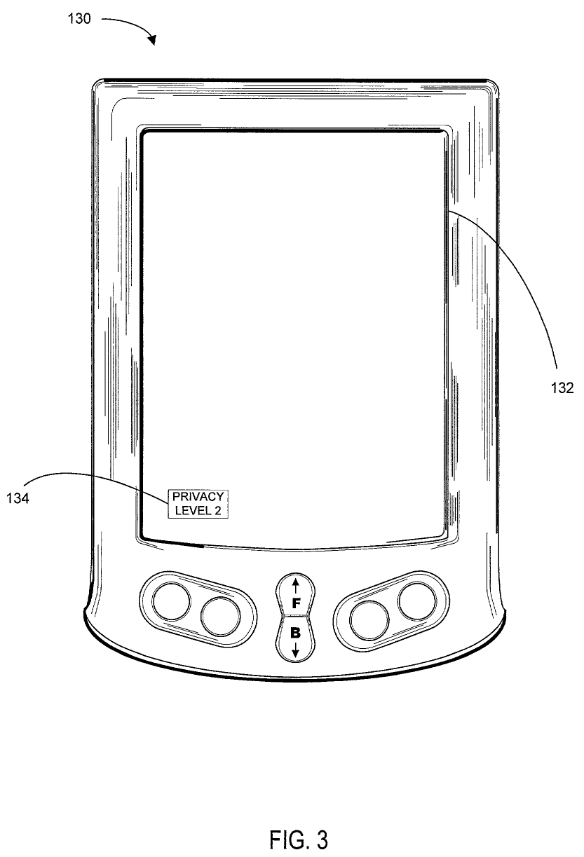

Another example of a visual display of a privacy notification is illustrated by a personal digital assistant 130 in FIG. 3. The personal digital assistant 130 includes a display 132 upon which a visual privacy notification or image 134 appears. The privacy notification 134 indicates a “PRIVACY LEVEL 2” for an interaction. In some embodiments, a privacy level of “2” may indicate that a service provider may disclose individualized information received from or collected about a user during an interaction between the service provider and the user.

Referring once again to FIG. 1, in some embodiments a privacy notification sent during the step 106 may be or include an identifier associated with an interaction or a user and/or service provider involved in or associated with the interaction; a privacy level identifier; a cookie; information regarding one or more of the privacy levels determined during the step 102, information regarding the privacy level determined during the step 104; a message or image indicative of the privacy level determined during the step 104; a message or image displayable by software operating on a device used during an interaction; etc. For example, during an interaction a service provider may want to store a cookie in a user device so that the service provider can easily determine during a future interaction what privacy level was used or associated with the earlier interaction. As another example, during an interaction between a user and a service provider, the user and/or service provider may provide information to a third party regarding the privacy level associated with the interaction. At a later time, the third party may verify the privacy level. In addition, the third party might store such information for later access or use by the user and/or the service provider.

In some embodiments the step 106 or providing a notification regarding a privacy level may be or include one or more of the following: providing the notification as a user conducts an interaction; providing the notification prior to a user conducting an interaction; providing the notification after the user conducts an interaction; providing an indication to a user of a selection of a privacy level and receiving from the user a consent to conduct an interaction in accordance with the selected privacy level; providing the notification prior to providing a Web page associated with an interaction to a user; providing the notification prior to allowing a user to receive a Web page associated with an interaction; delaying an interaction until a user receives the notification; delaying an interaction until a user confirms receipt of the notification; delaying an interaction until a user consents to specific privacy level (e.g., the privacy level determined during the step 104); providing the notification to a device associated with a user; providing the notification to a device being used by a user during an interaction; providing a communication indicative of a privacy level (e.g., the privacy level determined during the step 104) to software being used by a user during an interaction; etc.

In some embodiments, the step 106 or the method 100 may include receiving a confirmation of a receipt of the notification sent during the step 106 from a recipient of the notification, a device associated with the recipient, software used by a recipient, etc.

After the step 106, a service provider or other party conducting one or more of the steps of the method 100 may conduct the interaction between the service provider and the user. Presumably, at least part of the interaction will be conducted in accordance with the privacy level determined during the step 104 or at least one of the privacy levels determined during the step 102. A service provider or other party may provide a notification to a user if, for some reason, the interaction cannot be conducted, continued or completed in accordance with a specified or determined privacy level. Similarly, a service provider or other party may terminate an interaction if, for some reason, the interaction cannot be conducted in accordance with a specified or determined privacy level

In some embodiments, a user involved in an interaction with a service provider may want to change the privacy level associated with the interaction. Thus, the user may send a notification to the service provider, and/or another party or device, that the user wants to change privacy level, that the user is requesting a change in privacy level, that the user is authorizing a change of privacy level, or that the user has changed the privacy level associated with the interaction. Similarly, a service provider involved in an interaction, or another party or device, may want to change the privacy level associated with the interaction. Thus, the service party may send a notification to the user, and/or another party or device, that the service provider wants to change privacy level, that the service provider is requesting a change in privacy level, that the service provider is authorizing a change of privacy level, or that the service provider has changed the privacy level associated with the interaction. As a result, in some embodiments, the method 100 may include allowing a user, service provider, or other party or device to modify a privacy level associated with an interaction, modify a privacy level determined during the step 102 or the step 104, etc. Also, in some embodiments, the method 100 may include providing a notification to a user or other party or device if a change in privacy level has occurred for an interaction.

During an interaction between a user and a service provider, the user may provide data to the service provider, the service provider may determine or collect information regarding the user, etc. Thus, in some embodiments, the method 100 may include storing, using, sending, receiving, encrypting, decrypting, deleting, modifying, disclosing, etc. information or other data in accordance with a privacy level associated with the interaction. In some embodiments, expiration dates, validity codes, identifiers or other information may be associated with information or other data received or provided during an interaction.

Since a user and a service provider may engage in one or more interactions during a communication session between the user and the service provider, the method 100 may be used or conducted multiple times during the communication session or include determining a second of the privacy levels determined during the step 102 that applies to a second or later interaction between the user and the service provider during the same or a different communication session. In addition, the method 100 may include providing a notification to the user or another party or device regarding the privacy level applied to the second or later interaction.

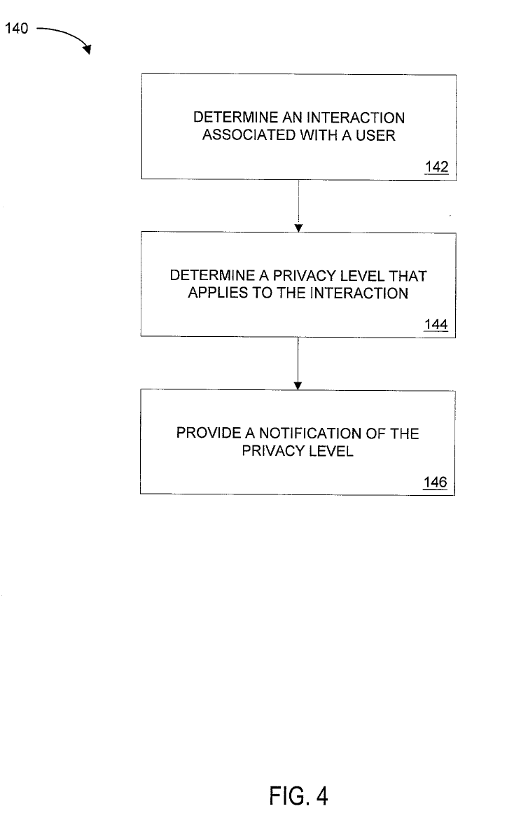

Reference is now made to FIG. 4, where a flow chart 140 is shown which represents the operation of a second embodiment of the present invention. The particular arrangement of elements in the flow chart 140 is not meant to imply a fixed order to the steps; embodiments of the present invention can be practiced in any order that is practicable. In some embodiments, some or all of the steps of the method 140 may be performed or completed by a server, user device and/or another device, as will be discussed in more detail below. In some embodiments, the method 140 may include some or all of the variations of the method 100 previously discussed above.

Processing begins at a step 142 during which an interaction associated with a user is determined. In some embodiments, the step 142 may be conducted prior to, during, or after the interaction. For example, prior to the interaction, a service provider may receive a request from a user to conduct the interaction. As another example, a third party may receive a notification of an interaction between a user and a service provider during or after the interaction. Thus, in some embodiments, the step 142 may be or include one or more of the following: receiving a request from a user to conduct a interaction; receiving an indication that a user and/or service provider has commenced an interaction; receiving an indication of the interaction from a user and/or service provider; receiving an indication of an interaction from a service provider involved in the interaction; etc.

During a step 144, one of a plurality of privacy levels is identified or otherwise determined that applies to the interaction determined during the step 142. The step 144 is similar to the step 104 previously discussed above. In some embodiments, the determination made during the step 144 may occur while the interaction is taking place, before the interaction has commenced, or after the interaction is completed.

In some embodiments, a service provider may provide a user with a list or description of one or more privacy levels that a user can select from for use with an interaction between the user and the service provider. The user can make a selection and provide a notification of the selection to the service provider.

In some embodiments, a service provider implementing the step 144 may determine what it is doing or what it intends to do with information collected from or about a user involved in an interaction. The service provider may then identify one of the privacy levels that applies or comports with the service provider's action or intention.

In some embodiments, a service provider implementing the step 144 may receive a notification, request, etc. from a user regarding a privacy level that the user wants applied to one or more interactions between the user and the service provider. Alternatively, the service provider may receive a request or other notification from a user or other party regarding a minimum privacy level or other privacy requirement that should be used during one or more interactions between the user and the service provider. The service provider can then determine which privacy level should be used to meet or exceed the minimum privacy level or privacy requirement specified by the user.

In some embodiments, a service provider may determine if a privacy level was used in one or more previous interactions between the service provider and a user. Such information may be found in a cookie previously stored on a device (e.g., a computer) associated with the user. The service provider then may apply the same privacy level to a current or new interaction between the service provider and the user.

In some embodiments the step 144 or determining which privacy level applies to an interaction between a service provider and a user may be or include one or more of the following: determining if any of a plurality of privacy levels were previously indicated by the user and/or service provider and/or another party as being acceptable; determining if any of a plurality of privacy levels were previously indicated as being acceptable by a party involved in the transaction; identifying at least one privacy level from a plurality of privacy levels that was applied during a previous interaction involving a party involved in the interaction; providing an indication to the user or other party of a selection of the one of a plurality of privacy levels and receiving from the user or other party a consent to conduct the interaction in accordance with the selected privacy level; receiving a request or instruction from a service provider and/or user to conduct the interaction in accordance with a specific privacy level; receiving a request or instruction from the service provider and/or user to conduct the interaction in accordance with a minimum privacy requirement and identifying or otherwise determining one of a plurality of privacy levels that at least meets the minimum requirement; receiving a request from a service provider and/or user to conduct the interaction in accordance with a specific requirement or other condition and identifying or otherwise determining one of a plurality of privacy levels that complies with the specific requirement or condition, etc.

During a step 146, a notification is provided regarding the privacy level determined during the step 144. The step 146 is similar to the step 106 previously discussed above. In some embodiments, a service provider or other party completing the step 146 may send the notification to a user before, during or after the interaction determined during the step 142. Similarly, in some embodiments, the service provider or the user may send the notification to another party (e.g., a party that monitors or verifies compliance of an interaction with a privacy level associated with the interaction) before, during or after the interaction. In some embodiments, a notification provided during the step 146 may be or include an icon, image, signal, message or other communication that is displayed on the user device or used to generate an icon, message, symbol, etc that is displayed on the user device. In some embodiments, the notification sent during the step 146 may include an audible component that is played by a device or used to generate an audible message, tone, sound, musical note, etc. indicative of the privacy level determined during the step 144.

In some embodiments the method 140 may include conducting or otherwise participating in the interaction determined during the step 142. In addition, in some embodiments, the method 140 may include establishing or otherwise determining one or more privacy levels in a manner similar to the step 102 previously discussed above. More specifically, establishing a plurality of privacy levels may be or include one or more of the following: receiving an indication of the plurality of privacy levels; selecting the plurality of privacy levels from privacy levels previously indicated by a user, service provider or other party to be acceptable; receiving an indication from a user and/or service provider of a group of privacy levels acceptable to the user and/or service provider and selecting a plurality of privacy levels from the group of privacy levels; receiving an indication from a party involved in an interaction of a group of privacy levels acceptable to the party and selecting the plurality of privacy levels from the group of privacy levels; receiving a request or instruction from a user, service provider and/or other party to conduct an interaction involving the user, service provider and/or other party in accordance with at least one of a plurality of privacy levels; etc.

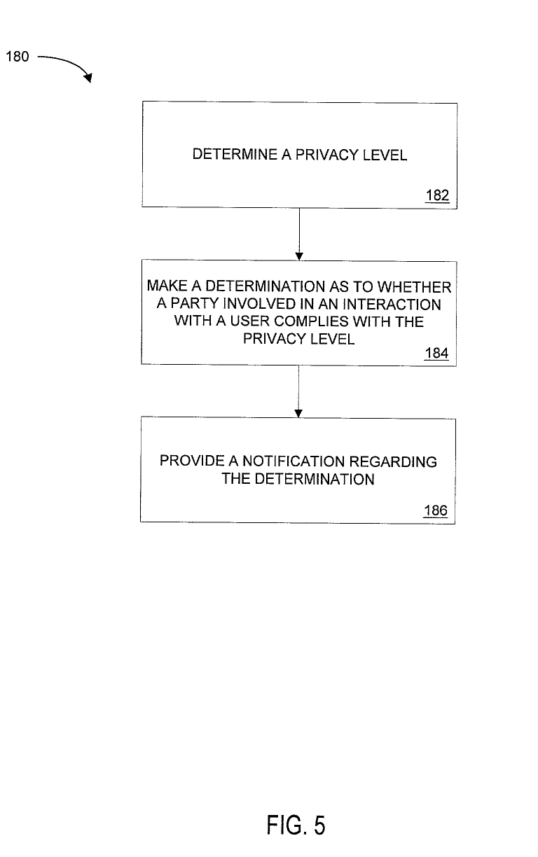

Reference is now made to FIG. 5, where a flow chart 180 is shown which represents the operation of a third embodiment of the present invention. The particular arrangement of elements in the flow chart 180 is not meant to imply a fixed order to the steps; embodiments of the present invention can be practiced in any order that is practicable. In some embodiments, some or all of the steps of the method 180 may be performed or completed by a server, user device and/or another device, as will be discussed in more detail below. In some embodiments, the method 180 may include some or all of the variations of the method 100 and/or the method 140 previously discussed above. The method 180 is particularly suited for implementation by a party that monitors compliance of one or more service providers with one or more privacy levels.

Processing begins at a step 182 during which a privacy level is identified or otherwise determined. In some embodiments, a party implementing the step 182 or the method 180 may complete the step 182 by receiving a notification from a user and/or service provider involved in an interaction of a privacy level applied or to be applied to the interaction; selecting a privacy level from a plurality of previously established or determined privacy levels; selecting the privacy level from a plurality of privacy levels previously indicated by a user, service provider or other party to be acceptable; receiving an indication from a user and/or service provider of a group of privacy levels acceptable to the user and/or service provider and selecting a privacy level from the group of privacy levels; receiving a request or instruction from a user, service provider and/or other party to conduct an interaction involving the user, service provider and/or other party in accordance with a specific privacy level, minimum privacy requirement, etc. or in accordance with at least one of a plurality of privacy levels; etc.

During a step 184, a determination is made regarding whether or not a service provider or other party involved in an interaction complies with the privacy level identified during the step 182. In some embodiments, the determination may be made during or after the interaction. For example, a party implementing the step 184 or the method 100 may determine if the party involved in an interaction provided proper notification to a user, service provider or other party of a privacy level associated with the interaction before, during or after the interaction; determining if the party's use, storage, transmission, reception, collection, decryption, encryption, etc. of data during or after the interaction complies with the privacy level; etc.

During a step 186, a notification is provided to a user, service provider or other party involved in, or otherwise associated with, the interaction. For example, a party that monitors or verifies compliance of a service provider with a privacy level during an interaction may provide a notification during or after the interaction to a user involved in the interaction regarding the service provider's compliance with a specific privacy level or regarding the privacy level used or applied by the service provider to the interaction. Thus, the party may determine if the service provider has actually complied with a privacy level supposed used by the service provider for a specific interaction, which may include monitoring later (e.g., after the interaction has ended) use, disclosure, storage, transmission, modification, etc. of data received by the service provider during the interaction.

As another example, a service provider may monitor or verify its own compliance with a privacy policy believed by the service provided to have been applied to an interaction. The service provider may provide a notification regarding its compliance or non-compliance to a user involved in the interaction or to another party that stores or uses compliance related information.

In some embodiments, a notification provided during the step 186 may be or include an icon, image, signal, message or other communication that is displayed on a device or used to generate an icon, message, symbol, etc that is displayed on a device. In some embodiments, the notification sent during the step 186 may include an audible component that is played by a device or used to generate an audible message, tone, sound, musical note, etc. indicative of the privacy level determined during the step 182.

In some embodiments, the step 186 may be or include one or more of the following: a party providing a notification that the party did or did not comply with a privacy level during or after an interaction; allowing a user involved in an interaction to retrieve information regarding a determination of a compliance with a privacy level during or after the interaction; a party providing a notification that the party exceeds or exceeded a privacy level during or after an interaction; providing a notification during or after an interaction to a user or service provider involved in the interaction; etc.

In some embodiments, the method 180 may include one or more of the following: conducting an interaction, monitoring an interaction, receiving a notification that a service provider or user is conducting or involved in an interaction, etc.

Any or all of the methods disclosed herein may be implemented as a computer program. In addition, a user or other party may implement browser, interface, front end or other software on a user device that displays icons, images, symbols, messages, or other notifications of a privacy level associated with an interaction. In some embodiments, such browser or other software may create an audible tone, sound, message, musical note, etc. as a notification to the user of a privacy level associated with an interaction. The software or device may receive a signal or other notification of a privacy level from a service provider or other party during or after an interaction and use the signal or other notification to create a visual and/or audible display, as illustrated in FIGS. 2 and 3. In embodiments where a party provides a notification to a user regarding a privacy level associated with one or more interactions engaged or participated in by the user, the notification may be or include an email message, instant message, beeper signal, facsimile transmission, or other form or format of electronic communication or signal.

In some embodiments, a computer program in a computer readable medium for providing notification of a privacy level may be or include first instructions for receiving data indicative of a level of privacy involved in an interaction; and/or second instructions for displaying on a device a notification indicative of the level of privacy. In some embodiments, the computer program or device may receive, use and/or store multiple signals indicative of one or more privacy levels and/or multiple images, icons, symbols, messages, sounds, tones, musical notes, etc. for indicating one or more privacy levels associated with one or more interactions.

System

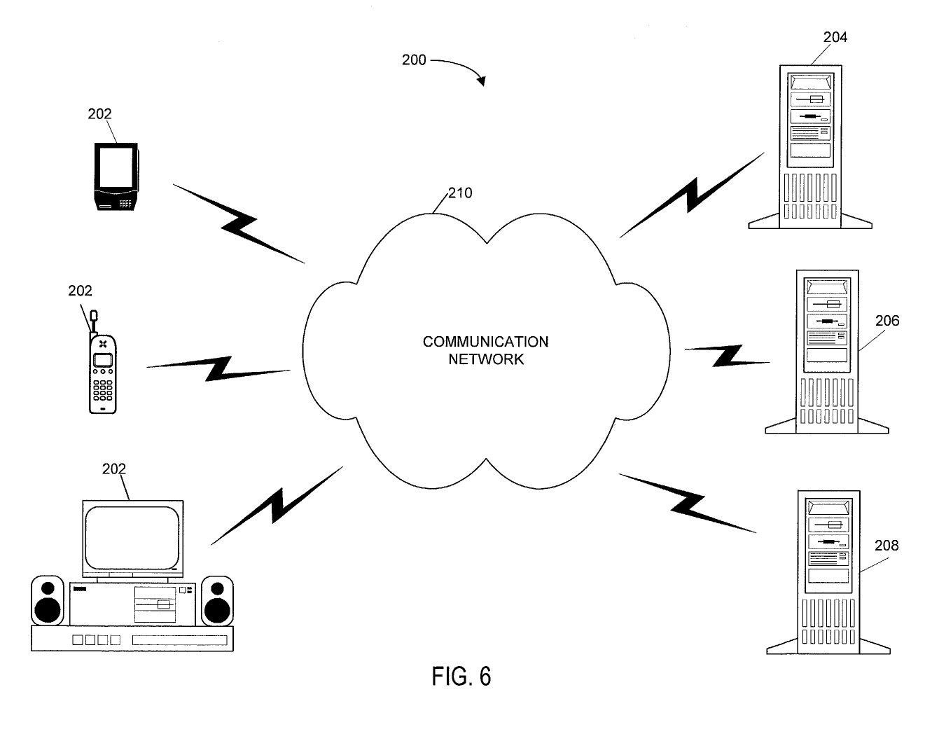

Now referring to FIG. 6, an apparatus or system 200 usable with the method disclosed herein is illustrated. The system 200 includes one or more user or client devices 202 that may communicate directly or indirectly with one or more servers, controllers or other devices 204, 206, 208 via a computer, data, peer-to-peer or communications network 210. For purposes of further explanation and elaboration of the methods disclosed herein, the methods disclosed herein will be assumed to be operating on, or under the control of, the server 204.

A server 204 may implement or host a Web site. A server 204 can comprise a single device or computer, a networked set or group of devices or computers, a workstation, etc. In some embodiments, a server 204 also may function as a database server and/or as a user device.

A server may be used by one or more service providers to provide information, services, etc. to one or more users. For example, a service provider might be or include an auction oriented Web site (e.g., www.ebay.com), an information oriented Web site (e.g., www.uspto.gov), a consumer products Web site (e.g., www.amazon.com), a Web portal (e.g., www.yahoo.com), etc. A service provider might use a server to allow access by users or other entities or devices to databases, email distribution lists, or other information stored on the server or under the control of the server. The use, configuration and operation of servers will be discussed in more detail below.

The user or client devices 202 preferably allow entities to interact with the server 204 and the remainder of the system 200. The user devices 202 also may enable a user to access Web sites, software, databases, etc. hosted or operated by the servers 204, 206, 208. If desired, the user devices 202 also may be connected to or otherwise in communication with other devices. Possible user devices include a personal computer, portable computer, mobile or fixed user station, workstation, network terminal or server, cellular telephone, kiosk, dumb terminal, personal digital assistant, etc. In some embodiments, information regarding one or more users and/or one or more user devices may be stored in, or accessed from, a user information database and/or a user device information database.

Many different types of implementations or hardware configurations can be used in the system 200 and with the methods disclosed herein and the methods disclosed herein are not limited to any specific hardware configuration for the system 200 or any of its components.

The communications network 210 might be or include the Internet, the World Wide Web, or some other public or private computer, cable, telephone, client/server, peer-to-peer, or communications network or intranet, as will be described in further detail below. The communications network 210 illustrated in FIG. 6 is meant only to be generally representative of cable, computer, telephone, peer-to-peer or other communication networks for purposes of elaboration and explanation of the present invention and other devices, networks, etc. may be connected to the communications network 210 without departing from the scope of the present invention. The communications network 210 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 204 without departing from the scope of the present invention. Moreover, as used herein, communications include those enabled by wired or wireless technology.

In some embodiments, a suitable wireless communication network 210 may include the use of Bluetooth technology, allowing a wide range of computing and telecommunication devices to be interconnected via wireless connections. Specifications and other information regarding Bluetooth technology are available at the Bluetooth Internet site www.bluetooth.com. In embodiments utilizing Bluetooth technology, some or all of the devices of FIG. 6 may be equipped with a microchip transceiver that transmits and receives in a previously unused frequency band of 2.45 GHz that is available globally (with some variation of bandwidth in different countries). Connections can be point-to-point or multipoint over a current maximum range of ten (10) meters. Embodiments using Bluetooth technology may require the additional use of one or more receiving stations to receive and forward data from individual user devices 202 or servers 204.

Although three user devices 202 and three servers 204, 206, 208 are shown in FIG. 6, any number of such devices may be included in the system 200. The devices shown in FIG. 6 need not be in constant communication. For example, a user device may communicate with a server only when such communication is appropriate or necessary.

Server

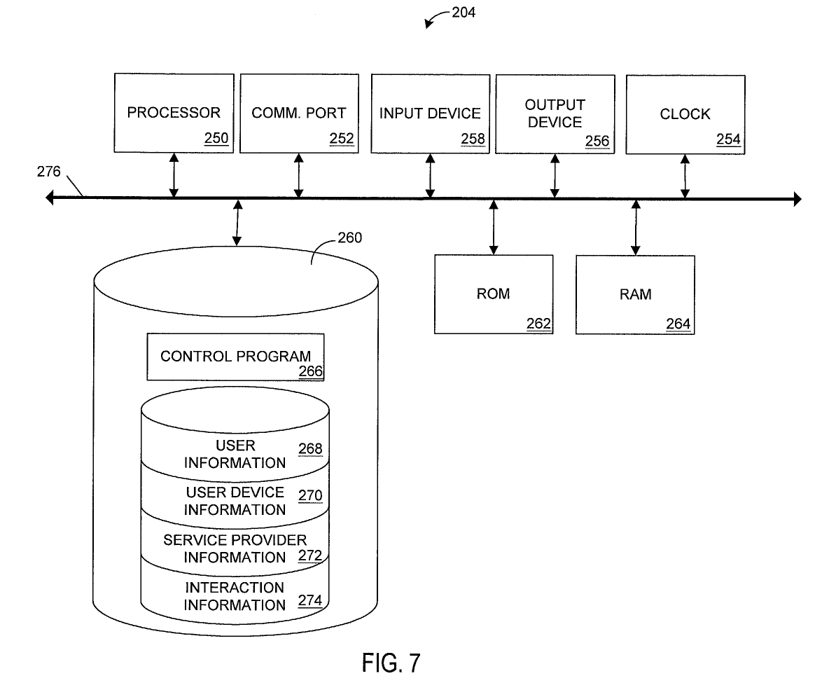

Now referring to FIG. 7, a representative block diagram of a server or controller 204 is illustrated. The servers 206 and 208 may include some or all of the components of the server 204. The server 204 may include a processor, microchip, central processing unit, or computer 250 that is in communication with or otherwise uses or includes one or more communication ports 252 for communicating with user devices and/or other devices. Communication ports may include such things as local area network adapters, wireless communication devices, Bluetooth technology, etc. The server 204 also may include an internal clock element 254 to maintain an accurate time and date for the server 204, create time stamps for communications received or sent by the server 204, etc.

If desired, the server 204 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 204 may include a memory or data storage device 260 to store information, software, databases, communications, device drivers, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 204 also may include separate ROM 262 and RAM 264.

The processor 250 and the data storage device 260 in the server 204 each may be, for example: (i) located entirely within a single computer or other computing device; or (ii) connected to each other by a remote communication medium, such as a serial port cable, telephone line or radio frequency transceiver. In one embodiment, the server 204 may comprise one or more computers that are connected to a remote server computer for maintaining databases.

A conventional personal computer or workstation with sufficient memory and processing capability may be used as the server 204. In one embodiment, the server 204 operates as or includes a Web server for an Internet environment. The server 204 preferably is capable of high volume transaction processing, performing a significant number of mathematical calculations in processing communications and database searches. A Pentium™ microprocessor such as the Pentium III™ microprocessor, manufactured by Intel Corporation may be used for the processor 250. Alternative processors are available from Motorola, Inc., AMD, or Sun Microsystems, Inc. The processor 250 also may comprise one or more microprocessors, computers, computer systems, etc.

Software may be resident and operating or operational on the server 204. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The server 204 also may include or store information regarding users, user devices, service providers, interactions, privacy levels, communications, etc. For example, information regarding one or more user may be stored in a user information database 268 for use by the server 204 or another device or entity. Information regarding one or more user devices may be stored in a user device information database 270 for use by the server 204 or another device or entity. Information regarding one or more service providers may be stored in a service provider information database 272 for use by the server 204 or another device or entity. Information regarding one or more interactions, and perhaps privacy levels associated with the interactions, may be stored in an interaction information database 274 for use by the server 204 or another device or entity. In some embodiments, some or all of one or more of the databases may be stored and/or mirrored remotely from the server 204.

According to an embodiment of the present invention, the instructions of the control program may be read into a main memory from another computer-readable medium, such as from the ROM 262 to the RAM 264. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 276.

While specific implementations and hardware configurations for servers 204 have been illustrated, it should be noted that other implementations and hardware configurations are possible and that no specific implementation or hardware configuration is needed. Thus, not all of the components illustrated in FIG. 4 may be needed for a server implementing the methods disclosed herein. Therefore, many different types of implementations or hardware configurations can be used in the system 200 and the methods disclosed herein are not limited to any specific hardware configuration.

User Device

As mentioned above, user device 202 may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, etc. In some embodiments, a user device 202 may have the same structure or configuration as the server 204 illustrated in FIG. 7 and include some or all of the components of the server 204.

Databases

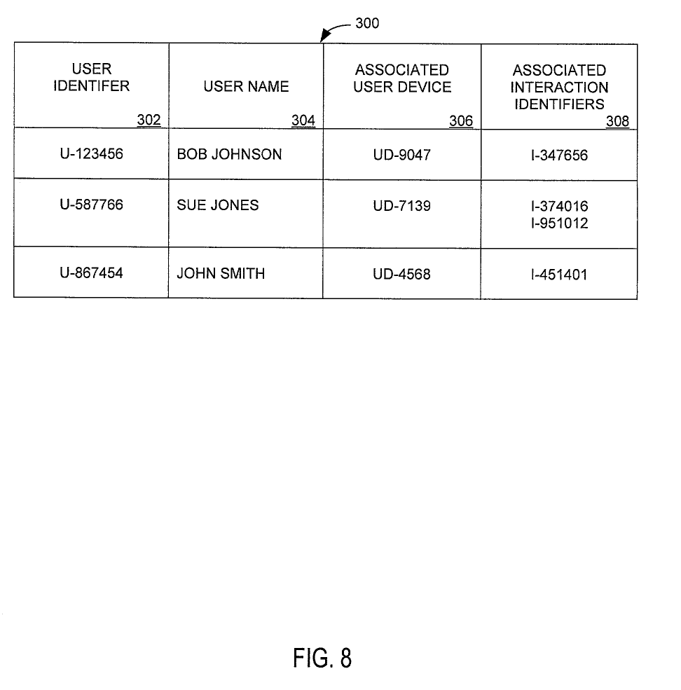

As previously discussed above, in some embodiments a server, user device, or other device may include or access a user information database for storing or keeping information regarding one or more users. One representative user information database 300 is illustrated in FIG. 8.

The user information database 300 may include a user identifier field 302 that may include codes or other identifiers for one or more users involved in one or more interactions, a user name field 304 that may include names or other descriptions for the users identified in the field 302, an associated user device field 306 that may include codes or other identifiers for user devices associated with the users identified in the field 302, and an associated interaction identifier field 308 that may include codes or other identifiers for interactions involving the users identified in the field 302. Other or different fields also may be used in the user information database 300. For example, in some embodiments a user information database may include a one or more fields that include location, personal, demographic or other information regarding the users identified in the field 302, a field that includes contact information (e.g., telephone numbers, email addresses, postal addresses) for the users identified in the field 302, a field that includes user satisfaction information regarding one or more interactions involving the users identified in the field 302, etc.

As illustrated by the user information database 300 of FIG. 8, the user identified as “U-123456” in the field 302 is named “BOB JOHNSON” and is associated with the user device identified as “UD-9047” in the field 306. The user identified as “U-123456” is associated with, or was involved in, the interaction identified as “I-347656” in the field 308. In some embodiments, a user may be associated with more than one user device, and vice versa. Similarly, a user may be associated with more than one interaction, and vice versa. In some embodiments, information regarding one or more user devices may be found in a user device information database while information regarding one or more interactions may be found in an interaction information database.

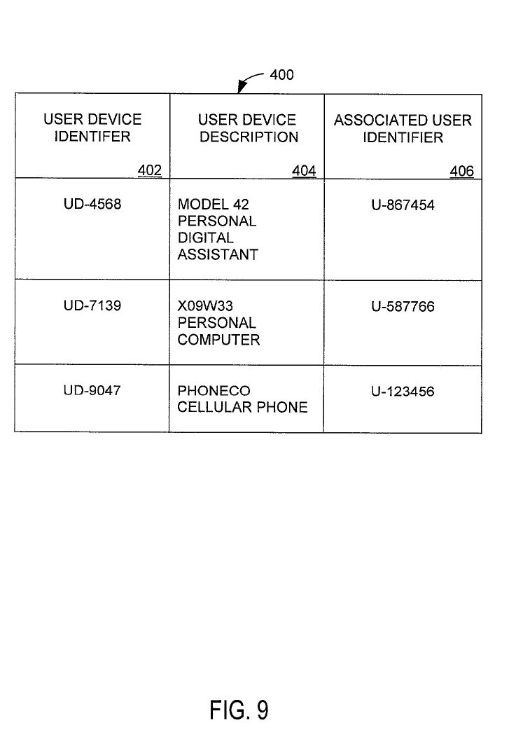

As previously discussed above, in some embodiments a server, user device, or other device may include or access a user device information database for storing or keeping information regarding one or more user devices. One representative user device information database 400 is illustrated in FIG. 9.

The user device information database 400 may include a user device identifier field 402 that may include codes or other identifiers for one or more user devices, a user device description field that may includes names, model numbers and/or other descriptive information for the user devices identified in the field 402, and an associated user identifier field 406 that may include codes or other identifiers for users associated with the user devices identified in the field 402. Other or different fields also may be used in the user device information database 400. For example, in some embodiments a user device information database may include operational or technical information (e.g., storage capacity, bandwidth), accessibility or availability information, contact information, location information, or other information regarding the user devices identified in the field 402. A user device may be associated with more than one user, and vice versa.

As illustrated by the user device information database 400 of FIG. 9, the user device identified as “UD-4568” in the field 402 is a “MODEL 42 PERSONAL DIGITAL ASSISTANT” and is associated with the user identified as “U-867454” in the field 406. In some embodiments, information regarding one or more users may be found in a user information database.

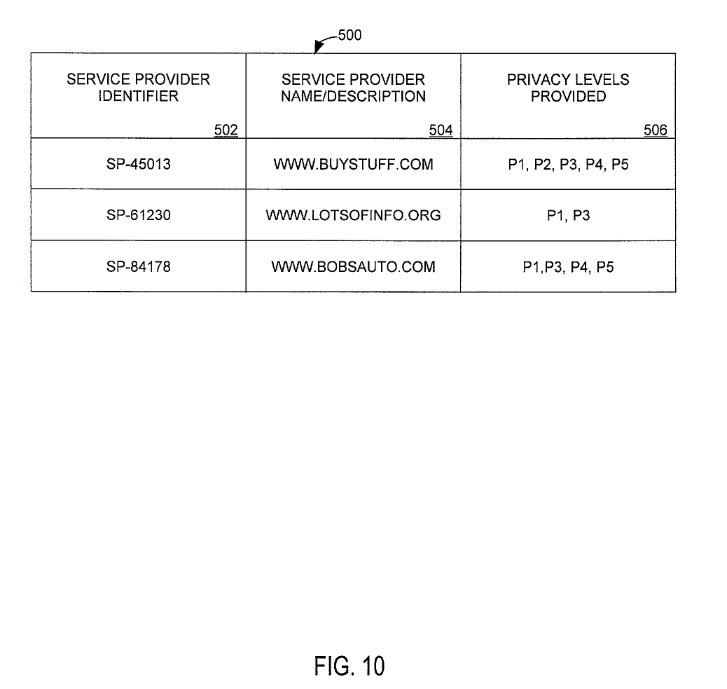

As previously discussed above, in some embodiments a server, user device, or other device may include or access a service provider information database for storing or keeping information regarding one or more service providers. One representative service provider information database 500 is illustrated in FIG. 10.

The service provider information database 500 may include a service provider identifier field 502 that may include codes or other identifiers for one or more service providers, a service provider name/description field 504 that may include names, contact information, URLs, descriptions, etc. for the service providers identified in the field 502, and a privacy levels provided field 506 that may include descriptions, codes or other identifiers indicating one or more levels of privacy provided by the service provider during interactions. Other or different fields also may be used in the service provider information database 500. For example, in some embodiments a service provider information database may include operational or technical information (e.g., storage capacity, bandwidth), accessibility or availability information, contact information, location information, or other information regarding the service providers identified in the field 502.

As illustrated by the service provider database 500 of FIG. 10, the service provider identified as “SP-45013” in the field 502 is the Web site found at “WWW.BUYSTUFF.COM” and provides five levels of privacy identified as P1, P2, P3, P4 and P5 in the field 506. In some embodiments, information regarding one or more privacy levels may be stored in a privacy, privacy requirements, or privacy level information database. Privacy level P1 may be an indicator of no privacy being afforded by a service provider during an interaction. Privacy level P2 may be an indicator that a service provider is recording or collecting data from or about a user during an interaction. Privacy level P3 may be an indicator that a service provider is disclosing or will disclose user information or other data as part of aggregate information collected from or about many users involved in an interaction. Privacy level P4 may be an indicator that a service provider is disclosing or will disclose individual user information or other data collected from or about a user involved in an interaction.

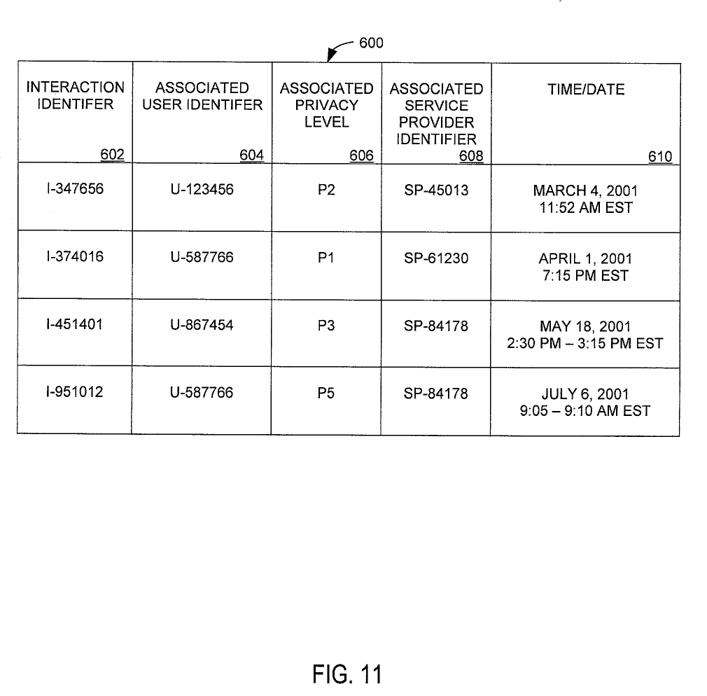

As previously discussed above, in some embodiments a server, user device, or other device may include or access an interaction information database for storing or keeping information regarding one or more interactions. One representative interaction information database 600 is illustrated in FIG. 11.

The interaction information database 600 may include an interaction identifier field 602 that may include codes or other identifiers for one or more interactions, an associated user identifier field 604 that may include codes or other identifiers for one or more users involved in or otherwise associated with the interactions identified in the field 602, an associated privacy level field 606 that may include codes, identifiers or other descriptions for privacy levels associated with or applied to the interactions identified in the field 602, an associated service provider field 608 that may include codes or other identifiers for one or more service providers involved in or otherwise associated with the interactions identified in the field 602, and a time/date field 610 that may include information regarding the time, date, etc. of the interactions identified in the field 602. Other or different fields also may be used in the interaction information database 600. For example, in some embodiments an interaction information database may include information describing the type of interaction (e.g., was as user purchasing an item, retrieving information), information describing activity of a user or a service provider involved in an interaction (e.g., did the user purchase one item after originally indicating an interest in more than one item, was the service provider offering a rebate or other incentive to the user during the interaction), etc.

As illustrated by the interaction information database 600 of FIG. 11, the interaction identified as “I-347656” in the field 602 involved the user identified as “U-123456” and the service provider identified as “SP-45013” at a privacy level identified as “P2”. The interaction identified as “I-347656” took place on Mar. 4, 2001, at 11:52 AM EST. In some embodiments, information regarding one or more privacy levels may be stored in a privacy requirements or privacy level information database.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, multi-processor or distributed computer system, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to a preferred embodiment thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for providing notification of a privacy level, comprising:
determining a plurality of levels of privacy;
determining one of said plurality of privacy levels that applies to a first interaction conducted by a user; and
providing a notification of said one of said plurality of privacy levels to said user.

2. The method of claim 1, wherein said determining a plurality of levels of privacy includes at least one of the following:
establishing said plurality of privacy levels;
receiving an indication of said plurality of privacy levels;
selecting said plurality of privacy levels from privacy levels previously indicated by said user to be acceptable to said user;
selecting said plurality of privacy levels from privacy levels previously indicated to be acceptable to a party involved in said first interaction;
receiving an indication from said user of a group of privacy levels acceptable to said user and selecting said plurality of privacy levels from said group of privacy levels;
receiving an indication from a party involved in said first interaction of a group of privacy levels acceptable to said party and selecting said plurality of privacy levels from said group of privacy levels;
receiving a request from a party to conduct each interaction involving said party in accordance with at least one of said plurality of privacy levels; and
receiving a request from said user to conduct each interaction involving said user in accordance with at least one of said plurality of privacy levels.

3. The method of claim 1, wherein said determining one of said plurality of privacy levels that applies to a first interaction conducted by a user includes at least one of the following:
determining if any of said plurality of privacy levels were previously indicated by said user as being acceptable;
determining if any of said plurality of privacy levels were previously indicated as being acceptable by a party involved in said transaction;
identifying at least one privacy level from said plurality of privacy levels that was applied during a previous interaction involving said user;
identifying at least one privacy level from said plurality of privacy levels that was applied during a previous interaction involving a party involved in said first interaction;
providing an indication to said user of a selection of said one of said plurality of privacy levels and receiving from said user a consent to conduct said first interaction in accordance with said selected one of said plurality of privacy levels;
providing an indication to a party involved in said interaction of a selection of said one of said plurality of privacy levels and receiving from said party a consent to conduct said first interaction in accordance with said selected one of said plurality of privacy levels;
receiving a request from said user to conduct said first interaction in accordance with said one of said plurality of privacy levels;
receiving a request from said user to conduct said first interaction in accordance with a minimum privacy requirement and determining one of said plurality of privacy levels that at least meets said minimum requirement; and
receiving a request from said user to conduct said first interaction in accordance with a specific requirement and determining one of said plurality of privacy levels that complies with said specific requirement.

4. The method of claim 1, wherein said providing a notification of said one of said plurality of privacy levels to said user includes at least one of the following:
providing said notification as said user conducts said first interaction;
providing said notification prior to said user conducting said first interaction;
providing said notification after said user conducts said first interaction;
providing an indication to said user of a selection of said one of said plurality of privacy levels and receiving from said user a consent to conduct said first interaction in accordance with said selected one of said plurality of privacy levels;
providing said notification prior to providing a Web page associated with said first interaction;
providing said notification prior to allowing said user to receive a Web page associated with said first interaction;
delaying said first interaction until said user receives said notification;
delaying said first interaction until said user confirms receipt of said notification;
delaying said first interaction until said user consents to said one of said plurality of privacy levels;
providing said notification to a device associated with said user;
providing said notification to a device being used by said user during said first interaction; and
providing a communication indicative of said one of said plurality of privacy levels to software being used by said user during said first interaction.

5. The method of claim 1, wherein said first interaction conducted by a user includes at least one of the following:
said user conducting a transaction with a service provider;
said user making a purchase;
said user accessing a Web site;
said user using a feature of a Web site;
said user downloading data from a Web site; and
said user providing data to a Web site.

6. The method of claim 1, wherein said notification includes at least one of the following:
an identifier associated with said user;
an identifier associated with said first interaction;
a privacy level identifier;
a cookie;
information regarding said plurality of privacy levels;
information regarding said one of said plurality of privacy levels;
a message indicative of said one of said plurality of privacy levels;
a message displayable by software operating on a device used by said user during said first interaction;
an image displayable by software operating on a device used by said user during said first interaction; and
an image indicative of said one of said plurality of privacy levels.

7. The method of claim 1, further comprising at least one of the following:
receiving a confirmation of receipt of said notification by said user;
receiving a confirmation of receipt of said notification by a device associated with said user;
receiving a confirmation of receipt of said notification by software used by said user during said first interaction.

8. The method of claim 1, further comprising:
receiving a notification indicative of a change of level of privacy during said first interaction.

9. The method of claim 1, further comprising:
receiving a request to change a level of privacy associated with said first interaction.

10. The method of claim 1, wherein at least one of said plurality of levels of privacy includes at least one of the following:
a requirement that said user be informed of data received by a party involved in said first interaction;
a requirement that said user be informed of a retention of data received by a party involved in said first interaction;
a requirement that said user be informed of a use of data received by a party involved in said first interaction; and
a requirement that said user be informed of a disclosure of data received by a party involved in said first interaction.

11. The method of claim 1, further comprising:
providing said notification to a party involved in said first interaction.

12. The method of claim 1, wherein at least one of said plurality of privacy levels is based on, at least in part, at least one of the following:
a request received from said user prior to said first interaction;
a request received from said user during said first interaction;
a request received from a service provider involved in said first interaction;
a type of data that may be provided during an interaction;
a type of data that may be provided by said user;
a type of data that may be received during an interaction;
a use of data provided by said user;
a request from said user regarding data provided by said user during said first interaction;
a requirement of said user regarding data provided by said user during said first interaction;
a disclosure of data provided by said user;
a party to which data received from a user may be provided; and
a use of data provided by said user.

13. The method of claim 1, further comprising:
storing data received during said first interaction in accordance with said one of said plurality of privacy levels.

14. The method of claim 1, further comprising:
using data received during said first interaction in accordance with said one of said plurality of privacy levels.

15. The method of claim 1, further comprising:
providing data received during said first interaction to a party in accordance with said one of said plurality of privacy levels.

16. The method of claim 1, further comprising:
deleting data received during said first interaction in accordance with said one of said plurality of privacy levels.

17. The method of claim 1, further comprising:
collecting data during said first interaction in accordance with said one of said plurality of privacy levels.

18. The method of claim 1, further comprising:
determining a second of said plurality of privacy levels that applies to a second interaction conducted by said user; and
providing a notification of said second of said plurality of privacy levels to said user.

19. The method of claim 1, further comprising:
changing a level of privacy applied to said first interaction during said first interaction; and
providing a notification to said user of a change in level of privacy applied to said first interaction.

20. The method of claim 1, further comprising:
conducting said first interaction in accordance with said one of said plurality of privacy levels.

21. The method of claim 1, further comprising:
terminating said first interaction if said first interaction cannot be conducted in accordance with said one of said plurality of privacy levels.

22. The method of claim 1, further comprising:
providing a notification to said user if said first interaction cannot be conducted in accordance with said one of said plurality of privacy levels.

23. The method of claim 1, further comprising:
allowing said user to modify at least one of said plurality of privacy levels.

24. The method of claim 1, further comprising:
modifying at least one of said plurality of privacy levels.

25. The method of claim 1, wherein said determining one of a plurality of privacy levels that applies to a first interaction occurs during said interaction.

26. The method of claim 1, wherein said determining one of a plurality of privacy levels that applies to a first interaction occurs after said interaction.

27. The method of claim 1, wherein said providing a notification of said one of said plurality of privacy levels occurs during said interaction.

28. The method of claim 1, wherein said providing a notification of said one of said plurality of privacy levels occurs after said interaction.

29. A method for providing notification of a privacy level, comprising:
determining an interaction associated with a user;
determining one of a plurality of privacy levels that is associated with said interaction; and
providing a notification of said one of said plurality of privacy levels.

30. The method of claim 29, wherein said determining an interaction associated with a user includes at least one of the following:
receiving a request from said user to conduct said interaction;
receiving an indication that said user has commenced said interaction;
receiving an indication of said interaction from said user; and
receiving an indication of said interaction from a service provider involved in said interaction.

31. The method of claim 29, wherein determining one of a plurality of privacy levels associated with said interaction includes at least one of the following:
determining if any of said plurality of privacy levels were previously indicated by said user as being acceptable;
determining if any of said plurality of privacy levels were previously indicated as being acceptable by a party involved in said transaction;
identifying at least one privacy level from said plurality of privacy levels that was applied during a previous interaction involving said user;
identifying at least one privacy level from said plurality of privacy levels that was applied during a previous interaction involving a party involved in said first interaction;
providing an indication to said user of a selection of said one of said plurality of privacy levels and receiving from said user a consent to conduct said first interaction in accordance with said selected one of said plurality of privacy levels;
providing an indication to a party involved in said interaction of a selection of said one of said plurality of privacy levels and receiving from said party a consent to conduct said first interaction in accordance with said selected one of said plurality of privacy levels;
receiving a request from said user to conduct said first interaction in accordance with said one of said plurality of privacy levels;
receiving a request from said user to conduct said first interaction in accordance with a minimum privacy requirement and determining one of said plurality of privacy levels that at least meets said minimum requirement; and
receiving a request from said user to conduct said first interaction in accordance with a specific requirement and determining one of said plurality of privacy levels that complies with said specific requirement.

32. The method of claim 29, wherein said providing a notification of said one of said plurality of privacy levels includes at least one of the following:
providing said notification to said user;
providing said notification to a party involved in said interaction;
providing said notification to a party not involved in said interaction.

33. The method of claim 29, further comprising:
establishing said plurality of privacy levels.

34. The method of claim 33, wherein said establishing said plurality of privacy levels includes at least one of the following:
receiving an indication of said plurality of privacy levels;
selecting said plurality of privacy levels from privacy levels previously indicated by said user to be acceptable to said user;
selecting said plurality of privacy levels from privacy levels previously indicated to be acceptable to a party involved in said first interaction;
receiving an indication from said user of a group of privacy levels acceptable to said user and selecting said plurality of privacy levels from said group of privacy levels;
receiving an indication from a party involved in said first interaction of a group of privacy levels acceptable to said party and selecting said plurality of privacy levels from said group of privacy levels;
receiving a request from a party to conduct each interaction involving said party in accordance with at least one of said plurality of privacy levels; and
receiving a request from said user to conduct each interaction involving said user in accordance with at least one of said plurality of privacy levels.

35. The method of claim 29, further comprising:
conducting said interaction in accordance with said one of said plurality of privacy levels.

36. The method of claim 29, wherein said determining one of a plurality of privacy levels that is associated with said interaction occurs during said interaction.

37. The method of claim 29, wherein said determining one of a plurality of privacy levels that is associated with said interaction occurs after said interaction.

38. The method of claim 29, wherein said providing a notification of said one of said plurality of privacy levels occurs during said interaction.

39. The method of claim 29, wherein said providing a notification of said one of said plurality of privacy levels occurs after said interaction.

40. A method for providing notification of a privacy level, comprising:
determining a privacy level;
making a determination as to whether a party involved in an interaction with a user complies with said privacy level; and
providing a notification regarding said determination.

41. The method of claim 40, wherein said determining a privacy level includes at least one of the following:
determining a privacy level indicated by said party as applying to said interaction;
receiving an indication from said party that said interaction was conducted in accordance with said privacy level;
receiving an indication from said party that said interaction is being conducted in accordance with said privacy level;
selecting said privacy requirement from a plurality of privacy requirements;
receiving a request from said party to conduct all interactions involving said party in accordance with said privacy level;
receiving a request from said party to conduct said interaction in accordance with said privacy level;
receiving a request from said party to conduct said interaction in accordance with a minimum privacy requirement; and
receiving a request from said party to conduct said interaction in accordance with a specific privacy requirement.
receiving a request from said party to conduct all interactions involving said party in accordance with said privacy level;
receiving a request from a user to conduct said interaction in accordance with said privacy level;
receiving a request from a user to conduct interaction in accordance with a minimum privacy requirement; and
receiving a request from a user to conduct said interaction in accordance with a specific privacy requirement.

42. The method of claim 40, wherein said making a determination as to whether a party involved in an interaction with a user complies with said privacy level includes at least one of the following:
determining if said party provided proper notification of said privacy level during said interaction;
making said determination during said interaction;
making said determination after said interaction is completed;
determining if said party's use of data received during said interaction complies with said privacy level;
determining if said party's storage of data received during said interaction complies with said privacy level;
determining if said party's collection of data during said interaction complies with said privacy level;
determining if said party's transmission of data during said interaction complies with said privacy level; and
determining if said party's reception of data during said interaction complies with said privacy level.

43. The method of claim 40, wherein said providing a notification regarding said determination includes at least one of the following:
providing a notification during said interaction that said party is not complying with said privacy level;
providing a notification after said interaction that said party did not comply with said privacy level during said interaction;
providing a notification after said interaction that said party did comply with said privacy level during said interaction;
providing a notification during said interaction that said party is complying with said privacy level;
allowing said user involved to retrieve information regarding said determination;
providing a notification that said party exceeds said privacy level if said party does, in fact, exceed said privacy level according to said determination;
providing a notification that said party does not exceed said privacy level if said party does not, in fact, exceed said privacy level according to said determination;
providing said notification to a user involved in said interaction during said interaction;
providing said notification to a user involved in said interaction after said interaction; and
providing said notification to said party.

44. The method of claim 40, further comprising:
receiving an indication that said user is conducting said interaction.

45. A computer program in a computer readable medium for providing notification of a privacy level, comprising:
first instructions for receiving data indicative of a level of privacy involved in an interaction; and
second instructions for displaying on a device a notification indicative of said level of privacy.

46. The computer program of claim 45, wherein said level of privacy is one of a plurality of possible levels of privacy for which notifications can be displayed on said device.

47. A system for providing notification of a privacy level, comprising:
a memory;
a communication port; and
a processor connected to said memory and said communication port, said processor being operative to:
determine a plurality of levels of privacy;
determine one of said plurality of privacy levels that applies to a first interaction conducted by a user; and
provide a notification regarding said one of said plurality of privacy levels to said user.

48. A computer program product in a computer readable medium for providing a notification of a privacy level, comprising:
first instructions for identifying a plurality of levels of privacy;
second instructions for identifying one of said plurality of privacy levels that applies to a first interaction conducted by a user; and
third instructions for sending a notification regarding said one of said plurality of privacy levels to said user.

49. A system for providing notification of a privacy level, comprising:
a memory;
a communication port; and
a processor connected to said memory and said communication port, said processor being operative to:
determine an interaction associated with a user;
determine one of a plurality of privacy levels that is associated with said interaction; and
provide a notification regarding said one of said plurality of privacy levels.

50. A computer program product in a computer readable medium for providing a notification of a privacy level, comprising:
first instructions for identifying an interaction associated with a user;
second instructions for identifying one of a plurality of privacy levels that is associated with said interaction; and
third instructions for sending a notification regarding said one of said plurality of privacy levels.
